(19) United States
(12) Patent Application Publication
(10) Pub. No.: US 2008/0217998 A1
(43) Pub. Date: Sep. 11, 2008

(54) RENEWABLE ENERGY POWER SYSTEMS

(76) Inventor: Daniel W. Parmley, Phoenix, AZ (US)

Correspondence Address: KEITH L. JENKINS, 2222 NORTH MCQUEEN ROAD #2069, CHANDLER, AZ, 85225, US

(21) Appl. No.: 12/124,883

(22) Filed: May 21, 2008

Related U.S. Application Data
(63) Continuation-in-part of application No. 11/361,490, filed on Feb. 25, 2006.
(60) Provisional application No. 60/656,622, filed on Feb. 26, 2005.
(60) Provisional application No. 60/701,610, filed on Jul. 23, 2005.
(60) Provisional application No. 61/038,776, filed on Mar. 23, 2008.

(51) Int. Cl. H02J 9/06

(52) U.S. Cl. 307/65; 307/66

(57) ABSTRACT

A UPS with a multi-port DC bus operable to couple a plurality of intermittent external DC sources and intermittent external DC loads is disclosed. The invention includes renewable energy power systems with a UPS having a multi-port DC bus and a responsive energy storage means electrically coupled to the multi-port DC bus. An embodiment includes a renewable energy power system with a UPS having a multi-port DC bus having an external DC load coupling for supporting an external DC load. Exemplary DC sources disclosed include a pole-mountable wind turbine assisted by ducted hot air created by the waste heat from a solar-voltaic array that is also an exemplary DC source. A parking lot solar power system is also disclosed that is both a DC source and at least one DC load. A cogeneration system using the AC output of the UPS and the AC output of a genset is provided.

### RELATED APPLICATIONS

The present application is a continuation-in-part of U.S. patent application Ser. No. 11/361,490 filed by the present inventor on Feb. 5, 2006 for RENEWABLE ENERGY POWER SYSTEMS which, in turn, is related to and claims priority from prior provisional application Ser. No. 60/656,622 filed Feb. 26, 2005, entitled “RENEWABLE ENERGY POWER SYSTEMS”. U.S. patent application Ser. No. 11/361,490 is also related to and also claims priority from prior provisional application Ser. No. 60/701,610 filed Jul. 23, 2005, entitled “RENEWABLE ENERGY POWER SYSTEMS”. The present application claims the benefit of Provisional Patent Application Ser. No. 61/038,776, filed by the present inventor on Mar. 23, 2008 for a POLE-MOUNTABLE WIND TURBINE SUPPORT SYSTEM.

### FIELD OF THE INVENTION

The present invention relates to systems for incorporating renewable energy systems into existing power systems. The present invention further relates to an uninterruptible power supply (UPS) operable to receive plural independent AC inputs and plural independent DC inputs and to provide at least one AC output and plural independent DC outputs to loads external from the UPS. The present invention yet further relates to such a UPS integrated with particular DC loads and DC sources.

### BACKGROUND OF THE INVENTION

Many commercial power consumers, such as hospitals and computer facilities require continuous backup electrical power. Existing systems use a UPS, consisting of a rectifier for changing commercial alternating current (AC) power to DC power. The output of the inverter is coupled to a DC bus to which is also coupled battery backup power. Finally, the DC bus is coupled at its output to an inverter for inverting DC into AC. The AC output of the UPS supplies a primary load, and if the commercial power fails, even momentarily, the batteries support the primary load until an emergency generator can be started and coupled to the primary load. Thus, seamless compensation for a failure of commercial power is intended.

U.S. Pat. No. 7,081,687 issued to Johnson for a POWER SYSTEM FOR A TELECOMMUNICATIONS FACILITY on Jul. 25, 2006 discloses an AC to DC power conversion that runs off of either AC utility power, or power provided by AC generators fueled with natural gas or propane. DC power is produced either by rectifying the input AC power, or by supplying hydrogen to fuel cells. The output of Johnson's system is DC power. Johnson supplies AC backup power via an independent hydrogen-fueled generator. While Johnson refers to his system as “uninterruptible”, Johnson does not disclose all parts of a conventional UPS: Johnson does not invert the DC power back into AC power. Johnson does not disclose supporting DC loads external to the UPS from the same bus that supplies the inverter that produces AC output. Johnson does not disclose receiving DC sources external to a UPS onto the same bus that supplies an inverter that produces AC output.

U.S. Pat. No. 7,244,524 issued to McCluskey, et al., for a METHOD AND SYSTEM FOR BALANCED CONTROL OF BACKUP POWER on Jul. 17, 2007 (hereinafter “McCluskey”). McCluskey also discloses an AC to DC rectifier that lacks the final stage of a conventional UPS: the conversion back into AC power through an inverter. Accordingly, McCluskey does not disclose supporting DC loads external to a UPS from the same bus that supplies the inverter that produces AC output. McCluskey does not disclose receiving DC sources external to a UPS onto the same bus that supplies an inverter that produces AC output.

European Patent Application Publication 0486130A2 by Divan for a SINGLE PHASE AC POWER CONVERSION APPARATUS published May 20, 1992 discloses an AC to AC conversion apparatus for AC output voltage variation at the input AC frequency. Divan's circuit can be made uninterruptible by the addition of an energy storage device. However, Divan does not disclose supporting DC loads external to a UPS from the same bus that supplies an inverter that produces AC output. Divan does not disclose receiving DC sources external to a UPS onto the same bus that supplies an inverter that produces AC output.

U.S. Pat. No. 6,184,593 issued to Jungreis for an UNINTERRUPTIBLE POWER SUPPLY on Feb. 6, 2001 discloses a conventional UPS with multiple external AC inputs being inverted to DC power and placed on the DC bus between the AC-DC rectifier and the DC/AC inverter. Jungreis also discloses external DC sources connected, through a DC-DC rectifier, to the DC bus in his UPS. Jungreis does not disclose supplying external DC loads from the UPS DC bus. While Jungreis delineates the UPS as not including his DC storage media (batteries or capacitors), the circuit of Jungreis is not uninterruptible without the DC storage media and, therefore, is not actually a UPS, regardless of how labeled. Accordingly, the DC storage media of Jungreis is not an external DC load to the UPS when charging, but is internal to the UPS.

U.S. Pat. No. 6,987,670 issued to Ahmed, et al., for a DUAL POWER MODULE POWER SYSTEM ARCHITECTURE on Jan. 17, 2006 (hereinafter “Ahmed”) discloses a modular approach to making AC/AC, AC/DC, DC/DC, and DC/AC power conversions. Ahmed nowhere discloses a UPS. Ahmed has an AC/AC rectifier, but there is no DC supply coupled into a DC bus to make the circuit uninterruptible. Accordingly, Ahmed does not disclose supporting DC loads external to a UPS from the same bus that supplies the inverter that produces AC output. Ahmed does not disclose receiving DC sources external to a UPS onto the same bus that supplies an inverter that produces AC output.

US Patent Publication 2005/0275386 by Jepsen, et al., for a POWER RECTIFIER was published Dec. 15, 2005 (hereinafter “Jepson”). Jepson discloses a plurality of DC sources feeding a single DC bus that feeds an inverter to produce AC power. Accordingly, Jepson does not disclose a conventional UPS nor supporting DC loads external to a UPS (or even external to his DC bus) from the same bus that supplies the inverter that produces AC output.

Batteries are expensive to purchase and maintain, and create significant environmental challenges and expenses upon disposal. Some modern systems use flywheel generators for providing temporary DC power in place of batteries. Some flywheels are made of steel and require about 3000 watts to operate in a steady state. These steel flywheels typically have recovery times substantially longer than their power production periods, making them unresponsive to repeated interruptions and variations in input power.

Current power systems, which seek to integrate various renewable-energy sources of power such as, without limitation, solar photovoltaic (PV), wind, geothermal, bio-diesel generators, and hydro systems, require significant infrastructure for connectivity and power conditioning. In renewable energy power systems that seek to exploit multiple sources of renewable energy, the costs can be commercially prohibitive. Typically, each separate renewable energy power source has it own infrastructure for producing AC current and synchronizing the phase or phases with the AC power line current. Even with systems using only a few sources, the significant infrastructure requirements impose undesirable initial costs and maintenance costs. Accordingly, what is needed are renewable energy power systems with reduced infrastructure, higher capacity for handling a variety of loads and sources, and which can be easily integrated into commercial power systems.

Modern hydrogen gas production systems based on electrolyzers are stand-alone systems with both high-pressure and low-pressure storage tanks. While a significant amount of energy is required to compress the hydrogen gas for storage, much of that energy is wasted because the storage pressure is much higher than many (but not all) end-user pressure tanks. For example, a hydrogen production facility may store hydrogen at approximately 7000 psi while hydrogen-fueled vehicles may store hydrogen at 4500 psi. The 2500 psi difference is much more than is needed to overcome conduit losses. Accordingly, what is needed are hydrogen gas production systems that are integrated with electrical renewable energy power systems and which permit recovery of some of the otherwise wasted pressure differential pressure energy in the stored hydrogen gas.

With the world at the beginning of the end of the carbon-fuel age, innovative approaches are needed to combine various renewable, or “green” energy sources to replace carbon-based fuels and their pollutant oxides of carbon. Non-polluting energy sources such as wind, solar, hydro, and geothermal energy sources must fully exploited to maintain a breathable atmosphere. In the field of wind turbines, vertical axis wind turbines have evolved from the Savonius rotor configuration through the Darrieus design and to the Gorlov helical turbine and the giromill designs. As a result, VAWTs have become commercially feasible. Methods of exploiting these devices are needed.

An exemplary opportunity for fuel conservation is in thermal control of parking for motor vehicles. A car parked in broad summer daylight in Phoenix, Ariz. may reach an internal temperature of 160 degrees Fahrenheit. To enable humans to occupy the vehicle, the temperature must be significantly reduced by the automobile's air conditioning unit, which consumes fuel. Not only the air inside the vehicle must be cooled, but the material of which the vehicle interior is made must be cooled down. A vehicle under shaded parking on the same Arizona summer day will reach the ambient temperature of 110 degrees Fahrenheit, requiring significantly less fuel to cool down the vehicle to an inhabitable temperature. In Northern tier states, winter weather can cool down an exposed vehicle to an uninhabitable temperature, and fuel must be consumed to heat it back up. In covered parking, the temperature is moderated, and less fuel is consumed.

Traditional engine-generator sets (“gensets”) produce extensive amounts of waste heat that is conventionally rejected through an air-cooled heat exchanger, or radiator. Larger commercial gensets have fans to drive the cooling air at high flow rates. The waste heat and the kinetic energy of the flowing air are normally wasted, as conventional heat exchangers needed to recapture the waste heat are generally considered commercially unfeasible. Solar voltaic arrays also generate substantial amounts of waste heat, with approximately 60% of the waste heat lost off the front surface of the array and 40% of the waste heat lost off the back plane of the array.

The conventional UPS has only one AC power output and no DC power outputs.

The use of regenerative braking on cranes is known. Vycon of Yorba Linda, Calif. uses steel flywheels for storing the energy created when the crane load is lowered. The steel flywheel has high-speed moving parts, and the maintenance and reliability issues that accompany high-speed moving parts.

To meet the above-mentioned needs, to solve the above-mentioned problems, and to improve upon the above-mentioned systems, applicant presents what follows.

### BRIEF SUMMARY OF THE INVENTION

The invention provides a renewable energy power system including a UPS with at least one UPS core in said UPS. The UPS core includes a multi-port DC bus and an external DC coupling operable to assist in coupling an external DC load to the multi-port DC bus. The external DC load is located exterior to the UPS. The renewable energy power system also includes a rapidly responsive energy storage device electrically coupled to the multi-port DC bus.

The renewable energy power system preferably further includes an external DC coupling operable to assist in coupling an external DC source to the multi-port DC bus. The external DC source is external to the UPS. The external DC source includes either at least one wind turbine or at least one regenerative braking generator. The at least one wind turbine may include a pair of pole-mountable wind turbines, a pole, and a support structure operable to support the pair of pole-mountable wind turbines on the pole. The support structure may be operable to move vertically on said pole and move the pair of pole-mountable wind turbines rotationally about said pole, responsive to changes in wind direction.

The renewable energy power system may further include a solar voltaic array and ductwork for directing air bearing waste heat from the solar voltaic array. The air bearing the waste heat is ducted to assist in driving the at least one wind turbine. The solar voltaic array is operable to be moved vertically on the pole and rotated at least partially about the pole.

The renewable energy power system may further include an AC engine-generator, wherein waste generator heat from the AC engine-generator is exchanged to driven air and the heated driven air is then ducted and vented to assist in driving the at least one wind turbine.

The renewable energy power system may also include an external DC source that includes at least one parking lot solar power system; an external DC load that includes at least one automotive charging station; and AC power provided from a utility grid or a local AC generator into the UPS. The local AC generator may be fueled with hydrogen gas produced by an electrolyzer at least partially powered concurrently by the solar voltaic array, the at least one wind turbine; and the AC grid power, all combined though the UPS. The parking lot solar power system includes a parking lot, a roof for providing shaded parking for at least one vehicle, the roof supported above at least a portion of the parking lot; at least one solar voltaic array mounted on the roof; a housing operable to support and assist in protecting the UPS core, a reverse feed switch, a backup AC generator; and the at least one rapidly responsive energy storage device; a power conduit from the solar voltaic array to the external DC coupling operable to assist in coupling a DC source; a power conduit from an external DC coupling, operable to assist in coupling the multi-port DC bus to the at least one automotive charging station.

The invention also provides a renewable energy power system including at least one UPS having the combination of a rectifier, operable to receive AC grid power and to rectify said AC grid power to DC power output; an inverter, operable to receive DC bus power and to invert said DC bus power to AC line power output; at least one multi-port DC bus electrically coupling the rectifier to the inverter; and at least one external DC coupling from the at least multi-port DC bus operable to assist in coupling at least one external DC load to the at least one multi-port DC bus, wherein the at least one external DC load is external to the UPS; and at least one responsive energy storage device electrically coupled to the at least one multi-port DC bus. The renewable energy power system may further include at least one external DC coupling to the multi-port DC bus operable to assist in coupling at least one external DC source, wherein said at least one external DC source is external to said at least one UPS. The at least one DC source includes at least one pole-mountable wind turbine. The at least one DC source further includes at least one solar voltaic array, the at least one solar array including ductwork for air bearing waste heat from the at least one solar voltaic array, wherein the air bearing the waste heat is ducted to assist in driving the at least one wind turbine. The at least one DC source may include at least one parking lot solar power system. The at least one DC load external to the at least one UPS includes at least one vehicle charging station. The at least one vehicle charging station includes an AC outlet and a plurality of DC outlets, each DC outlet of said plurality of DC outlets operable to supply a unique DC voltage.

The renewable energy power system, wherein the rectifier is further operable to receive an AC output of an AC regenerative braking generator and/or an AC output of an engine-generator set.

The invention also provides a renewable energy power system including at least one UPS having the combination of a rectifier, operable to receive AC power and to rectify the AC power to DC power output; an inverter, operable to receive DC bus power and to invert the DC bus power to AC line power output; at least one multi-port DC bus electrically coupling the rectifier to the inverter; at least one external DC coupling from the at least one multi-port DC bus operable to assist in coupling at least one external DC load to the at least one multi-port DC bus, wherein the at least one DC load is external to the UPS; and at least one external DC coupling to the at least one multi-port DC bus operable to assist in coupling at least one external DC source to the at least one multi-port DC bus, wherein the at least one DC source is external to the UPS; and at least one responsive energy storage unit electrically coupled to the at least one multi-port DC bus. The renewable energy power system wherein the at least one DC source includes at least one wind turbine generator and the at least one DC load includes a lamp, an automobile charging station, an electrolyzer, or other DC-powered device. The renewable energy power system, wherein the at least one DC source includes a solar voltaic array. The renewable energy power system, wherein the at least one wind turbine generator is driven by a wind turbine, said at least one wind turbine assisted in its rotation by a flow of waste-heated air. The renewable energy power system, wherein the waste-heated air comprises at least one of: exhaust from said engine of the engine-generator set; cooling air heated by a heat exchanger of the engine-generator set; air heated by convection over the surfaces of the engine-generator set; air bearing waste heat from the solar voltaic array. The renewable energy power system, wherein the engine-generator set is one of part of a cogeneration system that cogenerates the AC line power output from said UPS and AC power output from the engine-generator set; and part of a parallel AC power supply to the rectifier, the parallel AC power supply further including AC power from an AC regenerative braking generator. The renewable energy power system, wherein the engine of the engine-generator set drives a compressor having intercoolers, heat from the intercoolers of the compressor is exchanged to air to produce heated air, and the heated air is used to assist the rotation of the at least one wind turbine. The system may further include at least one hydrogen producer powered as an external DC load of the UPS, a conduit for compressed natural gas from the compressor; and at least one hythane mixing facility coupled to said at least one hydrogen producer and said conduit for compressed natural gas operable to mix the hydrogen and the compressed natural gas.

Also presented is a method of operating a renewable energy power system comprising the steps of: providing a UPS with a multi-port DC bus between an AC/DC rectifier and a DC/AC inverter and supplying DC power from the multi-port DC bus to at least one DC load external to the UPS via a DC power coupling to the multi-port DC bus.

Also presented is a method of operating a renewable energy power system comprising the steps of: providing a source of air bearing waste heat from an energy production source and controlling the flow of said heated air to assist in driving a wind turbine.

### BRIEF DESCRIPTION OF THE DRAWING

The above and other objects and advantages of the present invention will become more apparent from the following description taken in conjunction with the following drawing in which:

FIG. 1 is a block diagram view illustrating an exemplary embodiment of the renewable energy power systems according to the present invention;

FIG. 2A is a diagrammatic representation illustrating an exemplary embodiment of a solar parking lot incorporating the renewable energy power systems of FIG. 1, according to the present invention;

FIG. 2B is a diagrammatic representation illustrating an exemplary embodiment of a solar parking lot with a hybrid co-generation energy tower incorporating the renewable energy power systems of FIG. 1, according to the present invention;

FIG. 3 is a side elevation view illustrating an exemplary embodiment of a detail of the hybrid co-generation energy tower of FIG. 2B, according to the present invention;

FIG. 4 is a top plan view illustrating an exemplary embodiment of a detail of the hybrid co-generation energy tower of FIG. 2B, according to the present invention;

FIG. 5 is a front elevation view illustrating an exemplary embodiment of a detail of the hybrid co-generation energy tower of FIG. 2B and FIG. 4, according to the present invention;

FIG. 6 is a top plan view illustrating an exemplary embodiment of a detail of the hybrid co-generation energy tower of FIG. 5, according to the present invention;

FIG. 7 is a side elevation view illustrating an exemplary embodiment of a detail of the hybrid co-generation energy tower of FIG. 2B, according to the present invention;

FIG. 8 is a top plan view illustrating an exemplary embodiment of a detail of the hybrid co-generation energy tower of FIG. 2B, according to the present invention;

FIG. 9 is a front elevation view illustrating an exemplary embodiment of a detail of the hybrid co-generation energy tower of FIG. 2B, according to the present invention;

FIG. 10 is a top plan view illustrating an exemplary embodiment of a detail of the hybrid co-generation energy tower of FIG. 2B, according to the present invention;

FIG. 11 is a side elevation view illustrating an exemplary embodiment of a detail of the hybrid co-generation energy tower of FIG. 2B, according to the present invention;

FIG. 12 is a top plan view illustrating an exemplary embodiment of a detail of the hybrid co-generation energy tower of FIG. 2B, according to the present invention;

FIG. 13 is a side elevation view illustrating an exemplary embodiment of a detail of the hybrid co-generation energy tower of FIG. 2B, according to the present invention;

FIG. 14 is a side elevation cutaway view illustrating another exemplary embodiment of a detail of a hybrid co-generation energy tower, incorporating essential features of the renewable energy power systems of FIG. 1, according to the present invention;

FIG. 15 is a side elevation cutaway view further illustrating the exemplary embodiment of details of a hybrid co-generation energy tower of FIG. 14, according to the present invention;

FIG. 16 is a block diagram illustrating a regenerative cargo crane incorporating essential features of the renewable energy power systems of FIG. 1, according to the present invention; and

FIG. 17 is a block diagram illustrating a second regenerative cargo crane incorporating essential features of the renewable energy power systems of FIG. 1, according to the present invention.

### DETAILED DESCRIPTION OF THE DRAWING

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

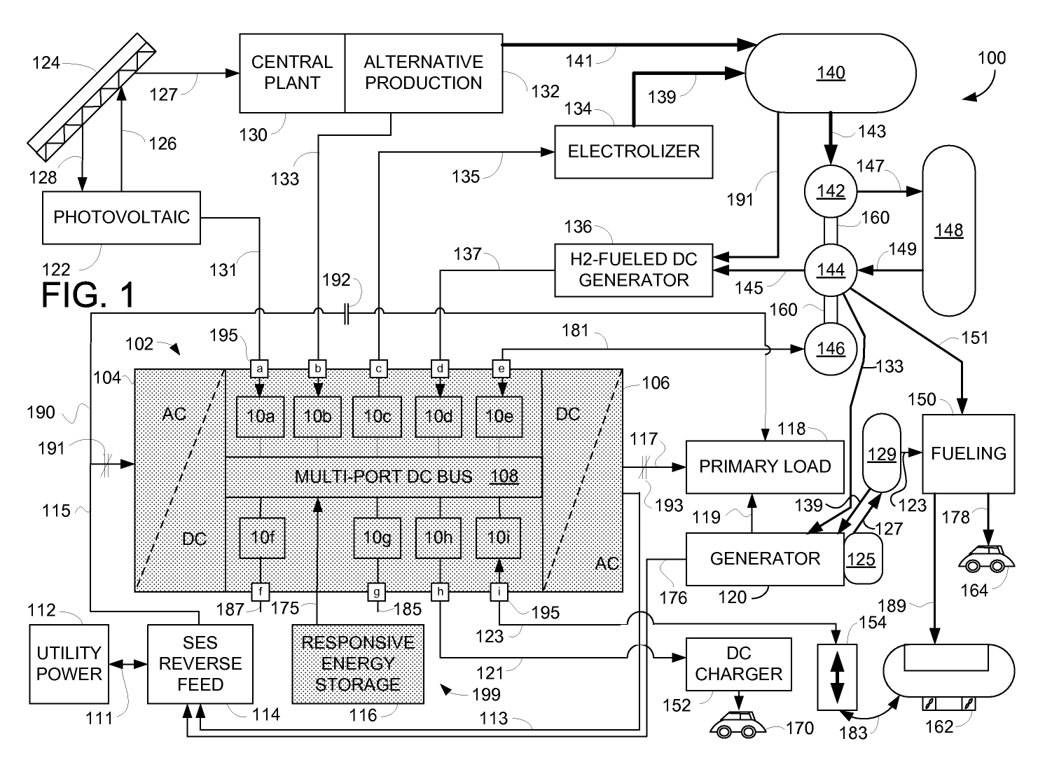

Turning now to FIG. 1, the exemplary embodiment of renewable energy power system 100 includes a UPS core 102 having a multi-port DC bus 108 featuring a plurality ports 195(a-i) (labeled by example) for coupling DC power lines 121, 123, 131, 133, 135, 137, 181, 187, 185, 121, and 123, respectively, to the multi-port DC bus 108 through regulators 10a-10i, respectively. (Two of the DC power lines are shown as spare DC power lines 185 and 187.) A “port” 195, as defined and used herein, is a power coupling to the multi-port DC bus 108 for a DC load or a DC source. The port may or may not couple through a regulator, such as one of regulators 10a-10i. The UPS core 102 includes a rectifier 104 that rectifies input AC power to DC bus power, an inverter 106, which inverts DC bus power to AC power, and a multi-port DC bus 108 that couples the DC output of the rectifier 104 to the input of the inverter 106. UPS 199 includes the UPS core 102 and responsive energy storage 116, as shown by shading in FIG. 1. A “multi-port DC bus” 108, as defined and used herein, is a DC bus coupled between the output of a rectifier 104 and the input of an inverter 106, and further having at least one port 195 for at least one external DC load, where the at least one external DC load is external to the UPS. Furthermore, the definition of “multi-port DC bus” 108 includes that the at least one DC port 195 is accessible on an exterior portion of the UPS 199. Preferably, the multi-port DC bus 108 includes a plurality of ports for supporting external DC loads and a plurality of ports for receiving power from a plurality of external DC sources.

“Responsive energy storage means 116” and particular examples thereof, as defined and used herein, are energy storage devices operable to store power, operable to supply that stored power in response to a power drop on the multi-port DC bus 108, and operable thereafter to re-store an amount of energy equal to that just supplied in approximately the same period of time that it used to supply that power. By “approximately equal” as used and defined herein, a recharge period less than or equal to 115% of the discharge period is considered “approximately equal”. Upon reading the teachings of this specification, those with ordinary skill in the art will now understand that, under appropriate circumstances, considering such issues as available energy sources, required energy loads, convenience, economics, user preference, etc., other configurations of multi-port DC buses 108, such as having more or fewer ports (but at least one externally accessible external DC load port), more or fewer regulators, more discrete or more integrated components, etc., may suffice.

The exemplary embodiment of renewable energy power system 100 further includes engine-generator 120, which is most preferably a hydrogen-powered engine-generator set producing AC power on AC power line 119 to the primary load 118 when signaled to produce power for the primary load 118. In various embodiments, generator 120 may be configured as a backup engine-generator 120 or as a co-generation engine-generator 120 designed for continuous operation. A co-generation generator 120 operates in parallel with utility power 112 to supply a primary load 118, as will be discussed in more detail below. In various embodiments, engine-generator sets using different fuels may be used for generator 120. For example, generator 120 may run on bio-diesel fuel, hydrogen, methane, or a mixture of hydrogen and methane known as “hythane”. A engine-generator set, available from Cummins or Caterpillar and which can run on hythane mixtures ranging from 100% hydrogen to 100% methane is preferred for embodiments where generator 120 is configured as a co-generator 120.

Generator 120 may also operate to produce AC power on AC power line 176 when signaled to do so. AC power line 176 may couple the generator 120 to the reverse feed switch 114 of renewable energy power system 100, which can couple AC power output to a commercial utility company's AC utility power grid 112 over AC power line 111, as shown. AC power line 115 may couple AC grid power from the AC power grid 112 to the input of the UPS core 102, as shown. The AC output of the UPS 199 may alternatively be supplied to the reverse feed switch 114 over AC power line 113, as shown. A maintenance bypass line 190 is used to bypass the UPS core 102 and UPS 199, if it should fail, and supply utility power 112 directly to the primary load 118. Normally closed switches 191 and 193 are opened for maintenance, and normally open switch 192 is closed for maintenance. Upon reading the teachings of this specification, those with ordinary skill in the art will now understand that, under appropriate circumstances, considering such issues as available generators, required energy loads, convenience, economics, user preference, etc., other sources for AC power, such as including both a dedicated AC genset that runs continuously and a backup generator, etc., may be appropriate.

The UPS core 102 comprises an AC/DC rectifier 104 supplying DC power to a multi-port DC bus 108, which supplies DC bus power to DC/AC inverter 106. The AC output of DC/AC inverter 106 supplies the primary load 118 over AC power line 117, as shown. The multi-port DC bus 108 may have a regulator, such as one of regulators 10a-10i, for each DC power line 121,123, 131, 13, 135, 137, 185, 187, and 181, coupled to the multi-port DC bus 108 for voltage regulation and current limiting. If a particular external power source or external load is self-regulating, a corresponding particular separate regulator 10a-10i may be omitted. In general, each renewable energy power system 100 should have no more components than are actually needed in a particular application. Likewise, the entire structure of the UPS core 102 and responsive energy storage means 116 should be environmentally sound as well as electrically effective. Upon reading the teachings of this specification, those with ordinary skill in the art will now understand that, under appropriate circumstances, considering such issues as available space, ambient environment, convenience, economics, user preference, etc., various configurations of UPS 199, such as including thermal control structures, vibration dampers, waterproofing, etc., may be appropriate.

Exemplary embodiment of renewable energy power system 100 further includes rapidly responsive energy storage means 116. Responsive energy storage means 116 operates to rapidly make up any drop in utility power 112 that impacts the input to multi-port DC bus 108 from rectifier 104. Responsive energy storage means 116 also operates to level any drop in photovoltaic power from PV array 122, any drop in alternative power from source 132, any drop in generator power from hydrogen-fueled DC generator 136, any drop in power from engine-generator 146, any drop in power through bi-directional coupling 154, or any drop in power through any other port. The supply-drop leveling occurs until either the commercial utility power 112 reacts to compensate for the drop or the generator 120, which may be configured as a generator 120, begins operation. For example, if responsive energy storage means 116 supplies 20 seconds of power from a fully ready state in response to the power grid 112 failing or the photovoltaic 122 power dropping due to a cloud, the responsive energy storage means 116 will return to the fully ready state in approximately 20 seconds. In order to provide constant power output from the UPS 199 while serving a wide range of intermittent power sources and loads connected to the multi-port DC bus 108, the system must have the capacity to rapidly compensate for falls in the net power level going from the multi-port DC bus 108 into the inverter 106. With a plurality of intermittent renewable energy sources and external loads connected to multi-port DC bus, several drops in power production may occur in a short period of time. The ability to level these variations is critical to the proper functioning of the UPS core 102. Accordingly, the development of rapidly responsive energy storage means 116 enables the present invention. Preferably, the UPS 199 is sized and configured to supply all loads from commercial utility power 112, and the addition of power from alternative sources 122, 133, 136, 146, and 162 reduces the amount of commercial utility power 112 consumed. Upon reading the teachings of this specification, those with ordinary skill in the art will now understand that, under appropriate circumstances, considering such issues as component cost, operational requirements, convenience, economics, user preference, etc., various configurations of UPS core 102 and responsive energy storage means 116, such as having multiple and/or various responsive energy storage means 116 coupled to the UPS core 102, having a load distribution logic to drop lower priority loads during low power production periods, having a power leveling logic to reduce demand for utility power 112 during high alternative energy production periods, etc., may be appropriate.

A comparatively new type of flywheel generator with a flywheel made of carbon fiber and available from Pentadyne Power Corporation of Chatsworth, Calif. requires only about 120 watts to operate in a steady state and has a recovery time approximately equal to its power production period. The present inventor has discovered that the rapidly responsive flywheel generator from Pentadyne can maintain bus voltage and power against a series of variations in input power and load. Each flywheel generator can produce about 120 kW. Multiple Pentadyne flywheel generators can be ganged together to handle larger loads. Accordingly, responsive energy storage means 116 may include Pentadyne flywheel generators.

Banks of ultra capacitors, produced by Maxwell Technologies of San Diego, Calif., can also function as rapidly responsive energy storage means 116. The present inventor has discovered that a rapidly responsive ultra capacitor bank from Maxwell Technologies can maintain bus voltage and power against a series of variations in input power and load. Ultra capacitor banks having the same energy storage capacity as the Pentadyne flywheel have about the same acquisition cost and require only about 15 watts of power in the quiescent state. Ultra capacitors recharge in the about same amount of time it takes to discharge them. In charging a discharged ultra capacitor, a pulse charging circuit is preferred to prevent shorting until a back EMF can build up in the ultra capacitor to create a resistance that avoids shorting. Additionally, the ultra capacitor banks have the advantage of having no moving parts. Accordingly, responsive energy storage means 116 preferably includes ultra capacitors, such as Maxwell Technologies ultra capacitors. In many embodiments, the ultra capacitor banks will be oversized compared to conventional UPS needs, in order to support external DC loads coupled to the multi-port DC bus 108. Upon reading the teachings of this specification, those with ordinary skill in the art will now understand that, under appropriate circumstances, considering such issues as component cost, operational requirements, technology advances, convenience, economics, user preference, etc., various types of responsive energy storage means 116, such as larger capacity ultra capacitors, combinations of batteries, Pentadyne flywheels, and Maxwell ultra capacitors, or other, as yet unknown rapidly responsive energy storage means 116 etc., may suffice. For example, nano-lithium-ion batteries have a more rapid discharge and recharge capability than lead-acid batteries, and may be appropriate in some embodiments.

Conventional lead-acid batteries and massive steel flywheel systems cannot re-store energy nearly as rapidly as they discharge it. Consequently, such conventional hardware does not enable a multi-port DC bus 108 coupled to a plurality of intermittent external power sources and external power loads.

Responsive energy storage means 116 is coupled to the multi-port DC bus 108 via power conduit 175 and is configured to compensate for any drops in DC power on the multi-port DC bus 108. The responsive energy storage means 116 is shown coupled directly to the multi-port DC bus 108 because it is preferably physically integral with the UPS core 102 to form the UPS 199. The ports 195 (a-i) are for external connections to the multi-port DC bus 108, as shown. Thus, if the utility AC power from the power grid 112 shuts off, responsive energy storage means 116 will maintain DC power on the multi-port DC bus 108 for a period deemed sufficient to bring a backup generator, which may be generator 120, online. Generator 120, when in operation, produces AC power that is coupled along AC power line 119 to supply primary load 118. In an alternative use, generator 120 may produce AC power to sell to the commercial power grid 112, supplying that power along AC power line 176, through the reverse feed switch 114 to the power grid 112. In yet another embodiment, the reverse feed switch 114 will enable generator 120 to supply power along AC power lines 176 and 115 to the input of UPS core 102 in order to assist in maintaining DC loads 134 and 152 as well as the primary AC load 118. Upon reading the teachings of this specification, those with ordinary skill in the art will now understand that, under appropriate circumstances, considering such issues as component cost, operational requirements, convenience, economics, user preference, etc., various configurations of responsive energy storage means 116, such as having multiple and/or various responsive energy storage means 116 coupled in series or parallel, etc., may be appropriate.

The multi-port DC bus 108 has a plurality of regulators 10 (a-i) to provide voltage regulation and current limiting between the multi-port DC bus 108 and various external DC loads and external DC sources. Each port 195(a-i) on the multi-port DC bus 108 may have an external DC source, an external DC load, or an element that is, at particular times, an external DC source and, at other times, an external DC load. Each port 195 (a-i) may include a regulator, such as one of regulators 10a-10i. The number of ports 195 (a-i) is not limited to the number shown in FIG. 1. Some ports 195 (a-i), such as port 195h coupled to electrical recharging station 152 by DC power line 121, port 195c coupled to electrolyzer 134 via DC power line 135, and port 195e coupled to DC engine-generator 146 via DC power line 181, provide temporally varying, or intermittent, loads to the multi-port DC bus 108. Such renewable energy power systems 100 are not feasible without responsive energy storage means 116 for leveling power on the multi-port DC bus 108. By gathering the power from all sources on the multi-port DC bus 108 in the UPS core 102 before conversion to AC power in the inverter 106, substantial reductions in infrastructure costs can be realized. Without a responsive energy storage means 116 with low operating costs, this approach would not be economically or technically feasible. Upon reading the teachings of this specification, those with ordinary skill in the art will now understand that, under appropriate circumstances, considering such issues as load characteristics, energy supply scheduling, operational requirements, convenience, economics, user preference, etc., various loads, such as AC loads with integral inverters, loads adaptable to scheduling and loads not adaptable to scheduling etc., may be incorporated.

DC output power line 135 couples DC power from port 195c to electrolyzer 134, which produces hydrogen gas from water and DC power. The hydrogen gas is coupled to low-pressure storage tank 140 over hydrogen gas conduit 139. Low-pressure hydrogen is pumped into high-pressure storage tank 148 though conduit 143, high-pressure pump 142, and hydrogen gas conduit 147. High-pressure pump 142 is mechanically coupled by drive shaft 160 to DC engine-generator 146, which is powered, in engine mode, from the multi-port DC bus 108 along DC power line 181 coupled to port 195e. When high-pressure hydrogen is needed from tank 148, the hydrogen is conducted through conduit 149 to a variable-aspect-vane turbine 144, which extracts mechanical power from a pressure differential between the high-pressure hydrogen gas tank 148 and the destination such as fueling station 150 and/or hydrogen-fueled DC generator 136. The extracted mechanical power rotates shaft 160 to turn DC engine-generator 146 in generation mode to produce power for the multi-port DC bus 108 via power line 181 coupled to port 195e. Upon reading the teachings of this specification, those with ordinary skill in the art will now understand that, under appropriate circumstances, considering such issues as operational requirements, alternative fuels availability, convenience, economics, user preference, etc., various configurations for the hydrogen gas conduits 141, 139, 143, 147, 149, 191, 145, and 151, such as for supplying a hydrogen-fueled generator 120, etc., may be appropriate.

Hydrogen-fueled DC generator 136, which may be one or more fuel cells and/or a hydrogen-fueled engine driving a DC generator, produces DC power and supplies the DC power along DC power line 137 to port 195d, though regulator 10d, and to the multi-port DC bus 108. Hydrogen-fueled DC generator 136 is fueled either directly from low-pressure tank 140 via conduit 191 or through conduit 145 from the pressure-dropping variable-aspect-vane turbine 144. Hydrogen may also be transferred along conduit 151 from the pressure-dropping variable-aspect-vane turbine 144 to a fueling station 150 and though releasable hydrogen conduit 178 to a hydrogen-fueled vehicle 164, or though releasable hydrogen conduit 189 to supply fuel or lifting gas for an airship 162, or to other end users of hydrogen. If airship 162 is equipped with solar photovoltaic arrays on its hulls, then the airship may be a source of DC power to multi-port DC bus 108 via releasable DC power line 183, bi-directional coupling 154, and DC power line 123. Conversely, if the airship 162 requires DC power, it can be supplied along the reverse route. Electric vehicle 161 can be charged from the multi-port DC bus 108 via regulator 10h, port 195h, DC power line 121, and electrical recharging station 152. Upon reading the teachings of this specification, those with ordinary skill in the art will now understand that, under appropriate circumstances, considering such issues as operational requirements, alternative fuels availability, convenience, economics, user preference, etc., various releasable hydrogen conduits and releasable DC power lines, adapted for respective various vehicles or destinations, etc., may be appropriate.

Generator 120 may drive a compressor 125 for compressing natural gas (methane) into compressed natural gas CNG and storing it, through gas conduit 127 in CNG storage tank 127. CNG may be supplied over gas conduit 123 to fueling station 150, where various mixtures of hythane may be produced and delivered to customers. CNG storage tank 127 may also supply CNG to generator 120 over gas conduit 139, where it may be mixed with hydrogen supplied over gas conduit 133 to create hythane mixtures, depending on the available supplies of each gas.

DC power from photovoltaic (PV) array 122 may be supplied along power line 131 to port 195a and regulator 10a to the multi-port DC bus 108. The PV array 122 may be cooled by heat exchanger 124 through coolant circulation conduits 126 and 128. Waste heat may be collected in central plant 130 where it may be used to generate DC power using any means of alternative production 132. The DC power generated in the alternative production facility 132 is supplied along power line 133 coupled to port 195b and through regulator 10b to the multi-port DC bus 108. Alternative production facility 132 may include, without limitation, wind power, hydroelectric power, geothermal power, solar power, sterling engine, or biogas generators. Alternative production facility 132 may also produce hydrogen gas, which is transferred to low-pressure storage tank 140 along conduit 141. Upon reading the teachings of this specification, those with ordinary skill in the art will now understand that, under appropriate circumstances, considering such issues as, operational requirements, alternative fuels availability, convenience, economics, user preference, etc., that any alternative production facility 132, such as tide-powered generators, landfill reclamation gas-powered generators, sewer-gas generators, etc., may be appropriate.

The exemplary embodiment illustrates a fully integrated system that can receive energy from multiple sources, including intermittent sources, and produce stable energy outputs for a plurality of loads. In particular, the exemplary embodiment can provide a stand-alone capability for logistical support of lighter-than-air twin hull hybrid airships such as those disclosed by the present inventor in U.S. Pat. No. 6,843,448. For purposes other than supporting airships, alternative embodiments may be used. In various alternative embodiments adapted to respective various opportunities and environments, more or fewer alternative energy sources and more or fewer external DC loads (but not fewer than one) may be preferred. For example, an isolated mountain town may make obvious variations in the design to avail itself of geothermal, wind, and hydroelectric sources and produce hydrogen as a prime mover fuel. In other embodiments, oxygen, which is a natural by-product of electrolyzing water in electrolyzer 134, may be used to supply a hospital, for improving ventilation (e.g., mines), or for various other purposes for which oxygen is useful. In a particular embodiment, such as a system deriving alternative energy from a volcanic lava flow, the hydrogen production subsystem may be omitted to reduce risk.

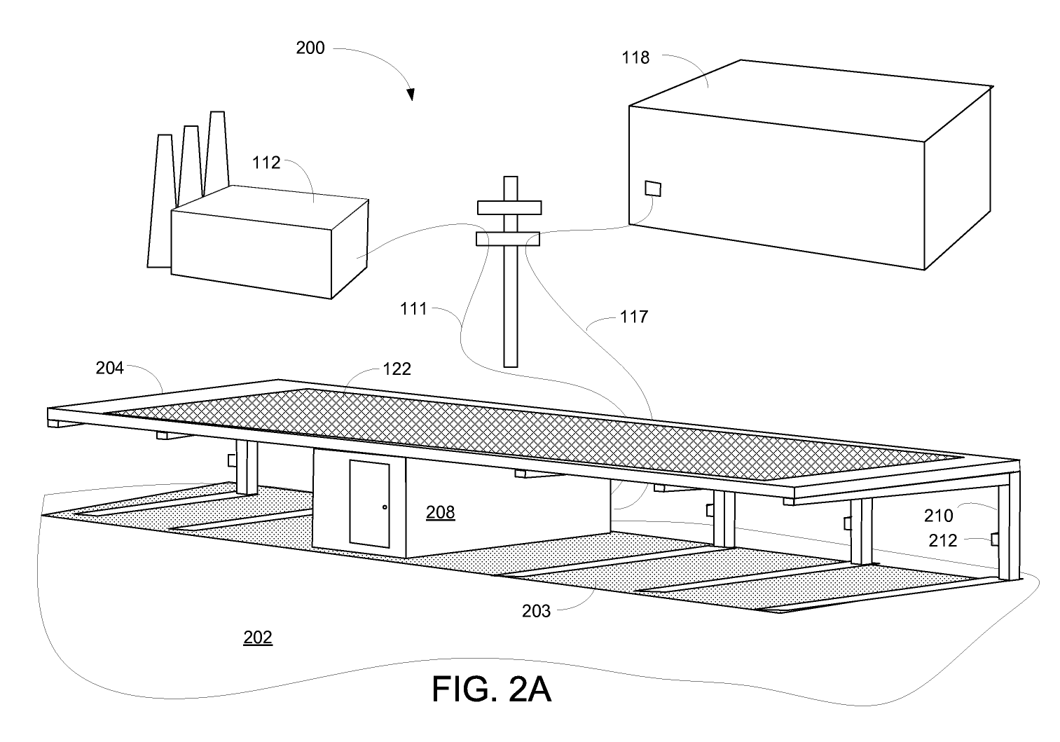

FIG. 2A is a diagrammatic representation illustrating an exemplary embodiment of a solar parking lot 200 incorporating the renewable energy power systems of FIG. 1, according to the present invention. Housing 208, preferably supports and protects a UPS 199, a generator 119, a reverse feed switch 114 and associated cabling and wiring. Housing 208 is preferably located in a parking lot 202 and is preferably sized to take up only one parking space. In some embodiments, housing 208 is an ISO container. Housing 208 may also partially support roof 204, which is also supported by supports 210. Roof 204 and supports 210 may be of types known in the art of covered parking, or may be of novel design. Preferably, supports 210 and roof 204 have channels for wiring. Roof 204 provides shade 203 over a portion of parking lot 202 and also supports solar voltaic array 122. Solar voltaic array 122 may be horizontally disposed on top of roof 204, as shown, or may be inclined, preferably at an angle approximately equal to the latitude of the parking lot location to improve energy collection. The electrical output of the solar voltaic array 122 is electrically coupled, via line 131 to external DC source coupling 195a and thence to the multi-port DC bus 108 via regulator 10a (see FIG. 1), which are located inside housing 208. Utility power 112 is conducted to the reverse feed switch 114 inside housing 208 via line 111, and then to the primary AC input of the UPS core 102 via line 115 (see FIG. 1).

One automotive charging station 212 is preferably attached to every support 210. Each automotive charging station 212 preferably includes a plurality of DC outlets, each at a unique commercially useful voltage and each representing one external DC load 152 to UPS 199 via a line such as 121, through a port such as 195h, through a regulator such as 10h, to multi-port bus 108. While most electric and hybrid electric vehicles in service today are designed to be charged with AC power, that AC is run through an rectifier in the car to change it to DC for charging the batteries in the car. By providing regulated DC power directly, and at the voltages in commercial use, the conversion step inside the car may be avoided. Each automotive charging station 212 preferably also includes an AC outlet for plugging in cars that can only be charged on AC. Each DC outlet and the AC outlet is uniquely configured so that the wrong plug cannot be accidentally inserted. The AC supplying the outlet is preferably the output AC power from the UPS 199. The generator 120 is preferably configured to supply power to the input of the UPS core 102, in order to support external DC loads when utility power 112 fails.

Primary load 118 is supplied from the output of the UPS core 102 inside housing 208 via line 117. Responsive energy storage means 116 maintains a constant power level on the multi-port DC bus 108 during intermittent solar energy supply and DC and AC demand.

FIG. 2B is a diagrammatic representation illustrating an exemplary embodiment of a solar parking lot 200 with a hybrid co-generation energy tower 300 incorporating the renewable energy power systems of FIG. 1 according to the present invention. The genset housing 220 contains and supports a engine-generator set for generating AC power. The engine of the genset preferably runs on hydrogen gas. The waste heat form the engine is transferred to air that is driven up through a ductwork inside the tower and directed onto two vertical wind turbines. The driving force behind the waste-heated air is a cooling fan blowing over a heat exchanger. The AC output of the genset may be routed directly to the primary load 118 via power conduit 119 or may be directed to the reverse feed switch 114 via power conduit 176. In this configuration, the genset is operating as a generator 120.

In a preferred embodiment, the genset housing 220 also contains a UPS core 102 and a responsive energy storage device 116, forming a UPS 199, and the genset AC output is coupled into the UPS core 102 through a reverse feed switch 114 in place of the utility power 112. DC power from solar array 122 and wind turbines 304 is coupled into DC source ports, such as 195a and 195b, on the UPS core 102 in the genset housing 220. The AC output of the UPS core 102 in the genset housing, created with the genset AC power, the solar array 122 DC power, and the wind turbine 304 DC power, is provided to a reverse feed switch 114 as primary power, and is coupled to second UPS core 102 in housing 208. The DC power from solar voltaic array 206 is fed into the multi-port DC bus 108 and adds to the power available from UPS 199. The USP 199 in housing 208 has external DC couplings to external DC loads, namely, the automotive recharging stations 212. The UPS 199 in the genset housing 220 has an external DC load, namely the cooling fan. The AC output from the UPS 199 in housing 208 is conducted to primary load 118 via power conduit 117.

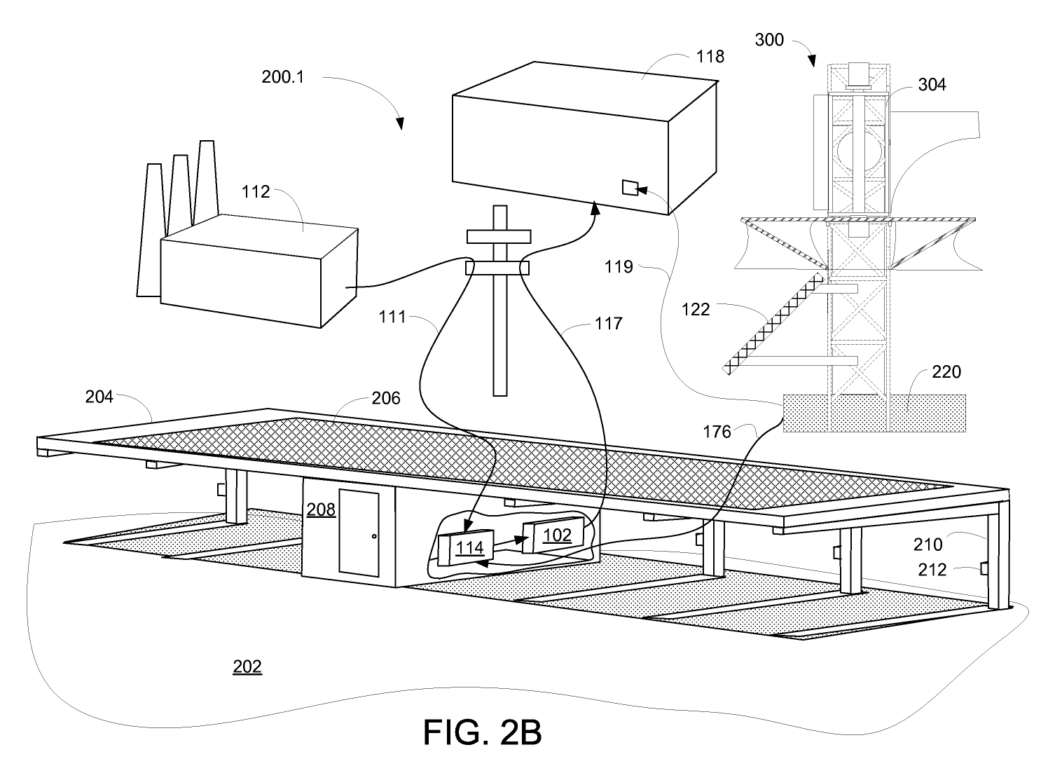

FIG. 3 is a side elevation view illustrating an exemplary embodiment of a detail of the hybrid co-generation energy tower 300 of FIG. 2B, according to the present invention and defines section A-A′. Pole-mountable wind turbine support system 300 is shown on pole 301 (shown as a box-beam truss). Support ring 302 may be annular and surrounds pole 303. Guides 310 are rotationally slidingly engaged to support ring 302 and are shaped to translationally slidingly engage the pole 303. Accordingly, support ring 302 may rotate about the axis of the pole. The support ring 302 need not be a monolithic structure, but should be designed to minimize weight, consistent with meeting design loads.

Support ring 302 supports VAWTs 304 symmetrically about the pole 301. Upper support ring 308 supports the upper ends of the VAWTs 304. Preferably, upper support ring 308 and support ring 302 are rigidly coupled together. VAWTs provide rotational mechanical energy to generators 305, which in turn produce DC power.

Vertical actuators 306 are operable to raise or lower the pole-mountable wind turbine support system 300 on the pole 301. While existing poles 301 are preferred, custom poles 301 for use with pole-mountable wind turbine support system 300 are within the scope of the present invention, as are modifications to existing poles 301. The advantage of the ability to raise and lower the pole-mountable wind turbine support system 300 is not only for maintenance, which is extremely difficult on many wind turbine installations. When the pole-mountable wind turbine support system 300 is used on a dual-use pole 301, it may be advantageous to lower the pole-mountable wind turbine support system 300 during the alternative use for the pole 301. For example, cargo cranes at major seaports are built with significant structural margins to deal with the variations in loads arising from various cargo weights and winds. When the crane is not operating, the structural margin of the crane support structure may be exploited by raising the pole-mountable wind turbine support system 300 and generating electricity. When the crane is in operation, the pole-mountable wind turbine support system 300 may be lowered to minimize the loading on the crane structure.

Vertical actuators 306 are preferably of the right-angle drive type, to avoid back-forces into the vertical actuator 306 and to ensure security of the system if the vertical actuators 306 fail. Other types of mechanical drives, known in the art to not transmit back-forces to the vertical actuators 306, may also be used.

Pole 301 may be, for example and without limitation, a crane, a bridge support, a building, or a pole 301 on which horizontal-axis propeller-type wind turbines are no longer being used. The pole 301 may be of any cross sectional shape, as adaptations to various cross-sectional shapes are within the scope of the present invention. The exemplary example pole-mountable wind turbine support system 300 shows two VAWTS 304. In some alternate embodiments, more than two VAWTs 304 may be used.

Solar voltaic array 122 is also mounted on pole 301 using supports 315 that link to a half-ring which permits the solar array 180 degrees of rotational motion about the pole 301. The motion is controlled by a motor controlled with a timer (not shown).

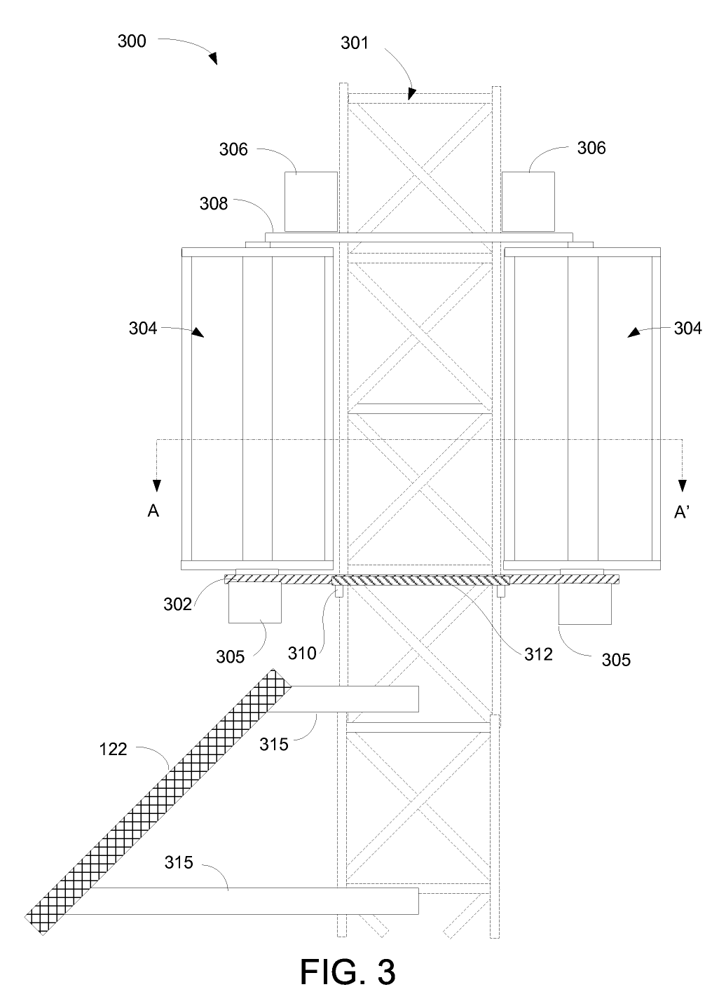

FIG. 4 is a top cross-sectional view A-A′ illustrating an exemplary embodiment of a detail of the hybrid co-generation energy tower 300 of FIG. 2B, according to the present invention. VAWTs 304 are supported by beams 302 which are rigidly attached to half-ring 313 of a split ring 312-313. The split ring 312-313 allows 360 degrees rotation about the pole 301 when the VAWTs 304 are raised to an operational position. Half-ring 313 permits the VAWTs 304 to be lowered for maintenance.

Genset housing 220 produces a waste-heat air stream that is driven up ductwork 404 and diverted by vents 402 to drive VAWTs 304.

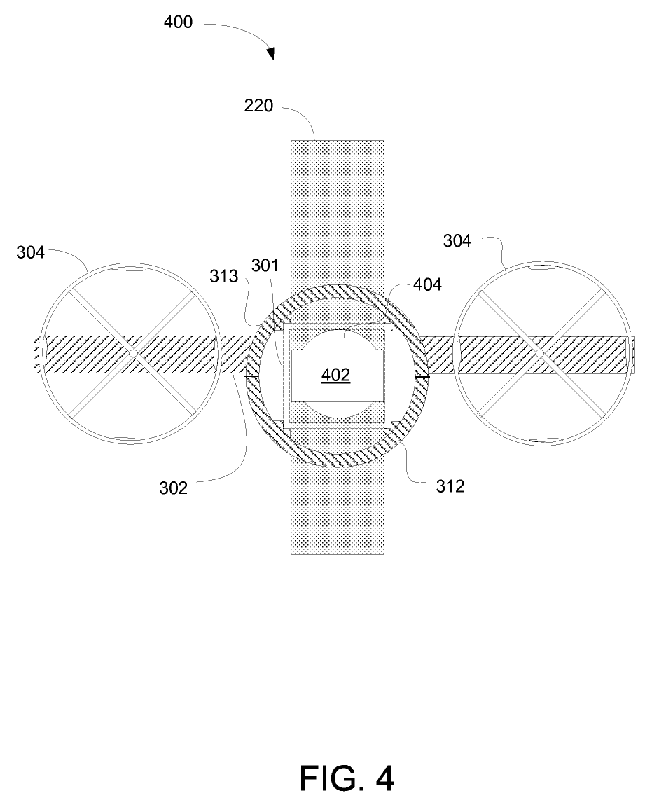

FIG. 5 is a front elevation view illustrating an exemplary embodiment of a detail of the hybrid co-generation energy tower 300 of FIG. 2B and FIG. 4, according to the present invention. The dimensions of the solar voltaic array 122 should not significantly greater that the span of the VAWTs 304.

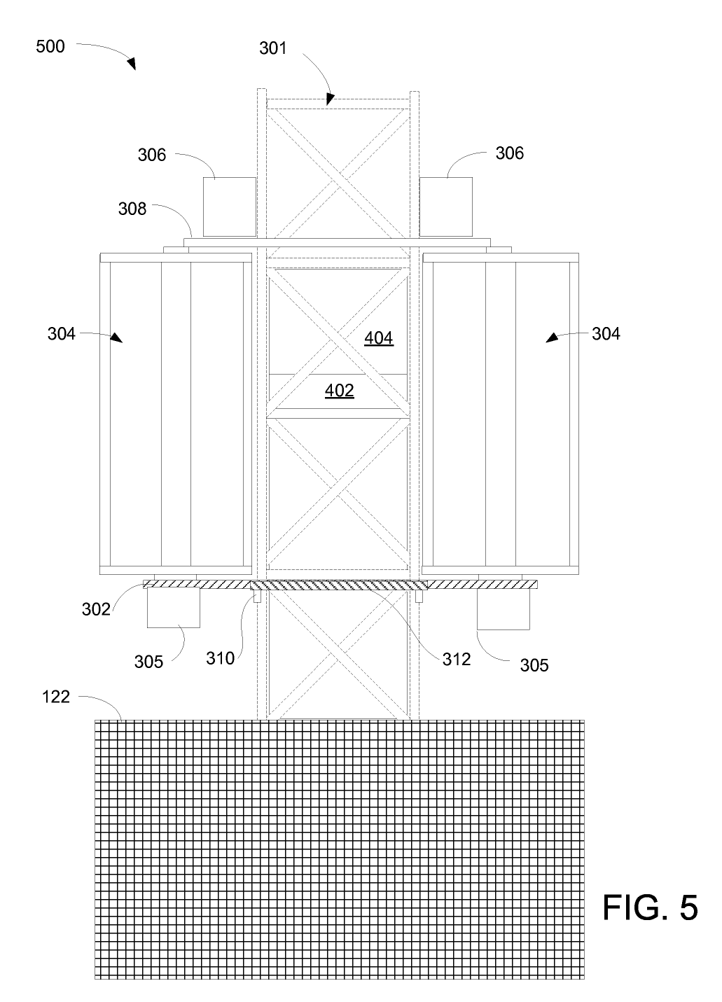

FIG. 6 is a top cross-sectional plan view illustrating an exemplary embodiment of a detail of the hybrid co-generation energy tower 300 of FIG. 5, according to the present invention. In comparing FIG. 4 and FIG. 6, it can be seen that the VAWTs 304 may be used with or without a solar voltaic array 122.

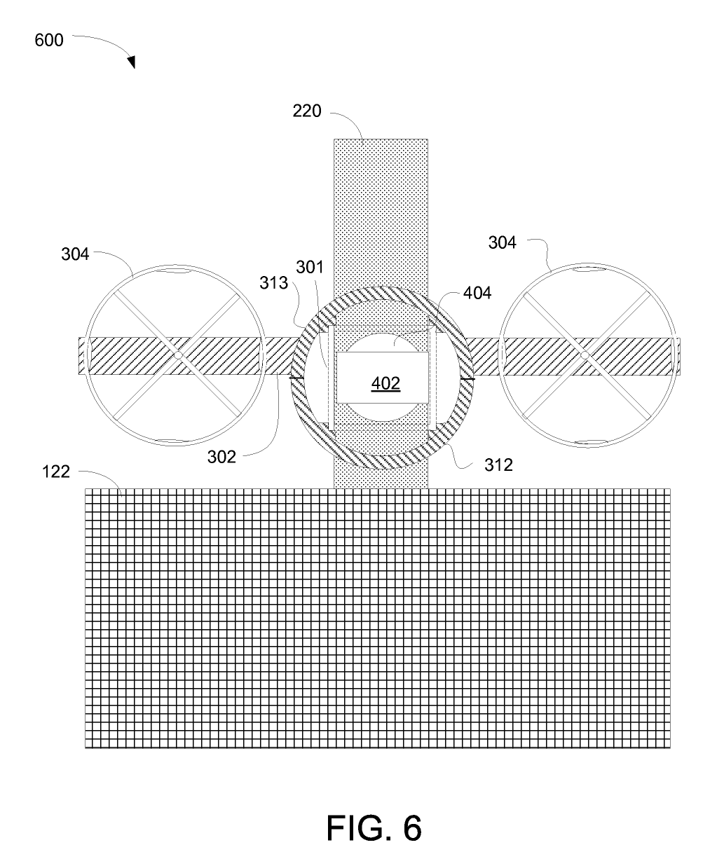

FIG. 7 is a side elevation view illustrating an exemplary embodiment of a detail of the hybrid co-generation energy tower 300 of FIG. 2B, according to the present invention. Genset housing 220 is approximately 8 feet tall, and the solar voltaic array 122 is preferably operated at a height sufficient to allow trucks to park underneath it.

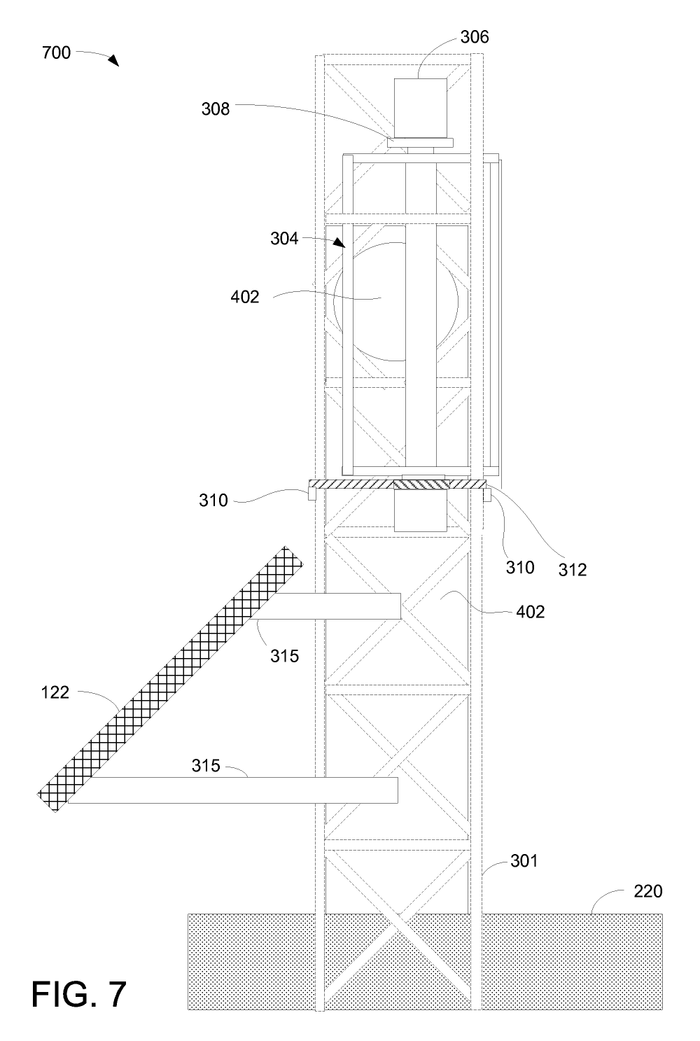

FIG. 8 is a top plan view illustrating an exemplary embodiment of a detail of the hybrid co-generation energy tower 300 of FIG. 2B, according to the present invention. FIG. 8 shows the addition of a ducting support ring 802, which is supported by struts (see FIG. 1) extending from the tower 301.

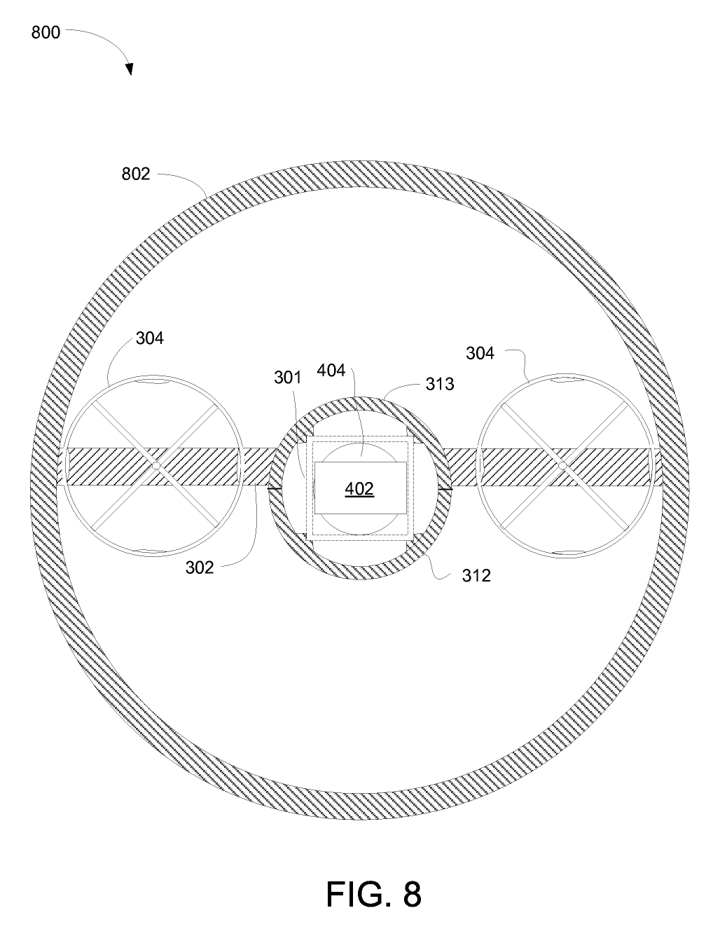

FIG. 9 is a front elevation view illustrating an exemplary embodiment of a detail of the hybrid co-generation energy tower 300 of FIG. 2B, according to the present invention. Ducting 902 is suspended from the ducting support ring 802 and functions to collect the waste heat, in the form of heated air, rising from the solar voltaic array 122.

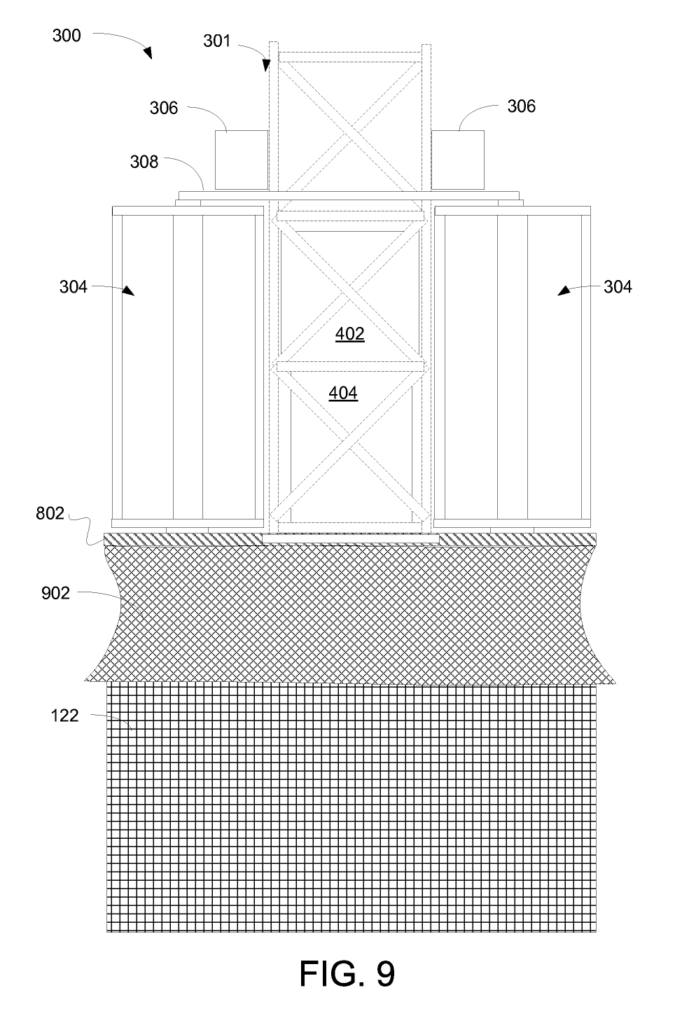

FIG. 10 is a top plan view illustrating an exemplary embodiment of a detail of the hybrid co-generation energy tower 300 of FIG. 2B, according to the present invention. Disc 1002 captures the rising heated air from the solar voltaic array 122 and directs it to vents 1004. Tail 1006 serves to keep the VAWTs facing the wind (from bottom of the page, as shown). Cowling 1008 reduces unsteady flow about the pole 301 proximate the VAWTs 304.

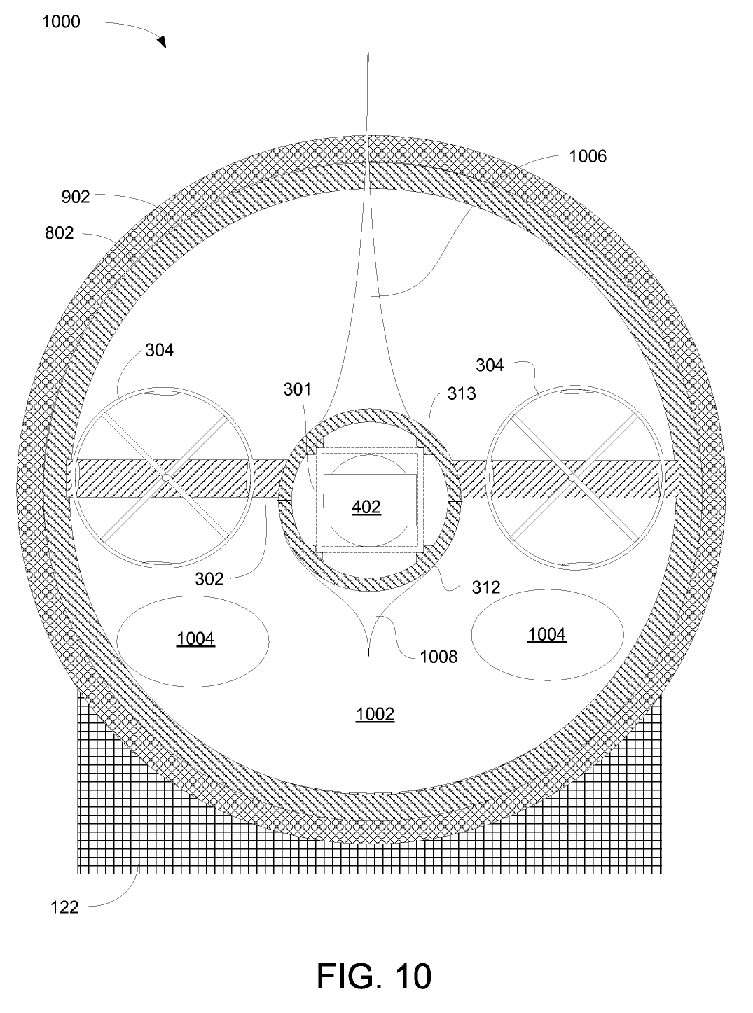

FIG. 11 is a side elevation view illustrating an exemplary embodiment of a detail of the hybrid co-generation energy tower 300 of FIG. 2B, according to the present invention. FIG. 11 shows a cross-section of the ducting 902, revealing the struts 1102 and the internal ducting 1104. Ducting 902 is preferably transparent, to avoid loss of solar power. The ducting 902 and 1104 form an annular duct that rotates with the VAWTs but continues to cover the up flow from solar voltaic array 122.

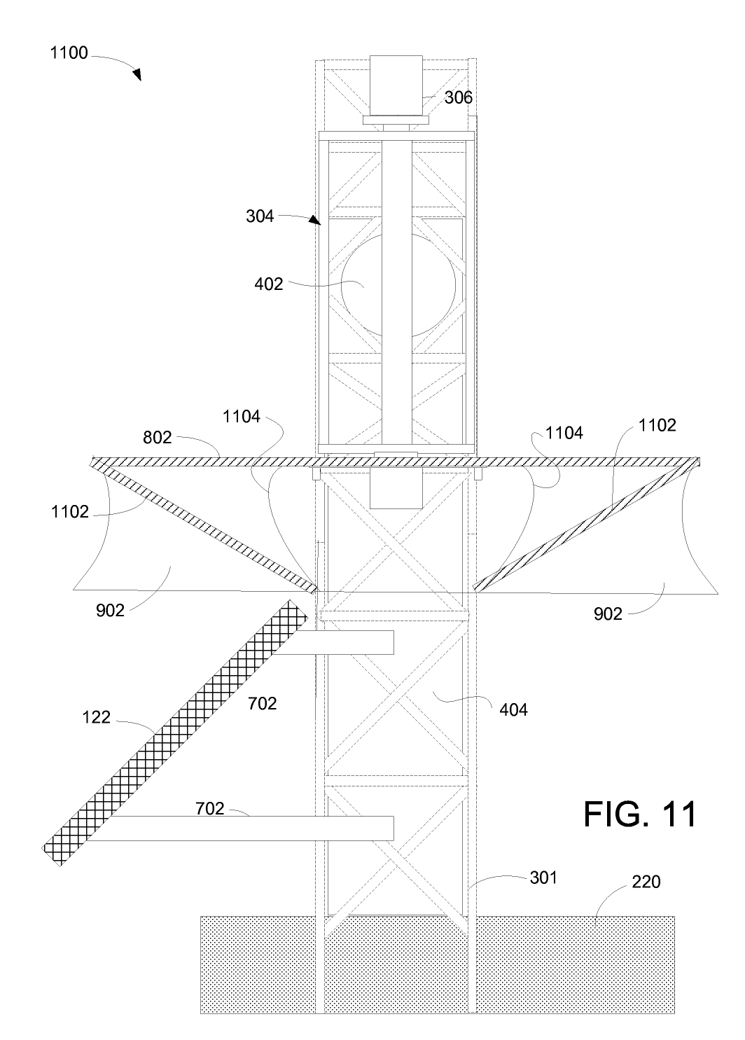

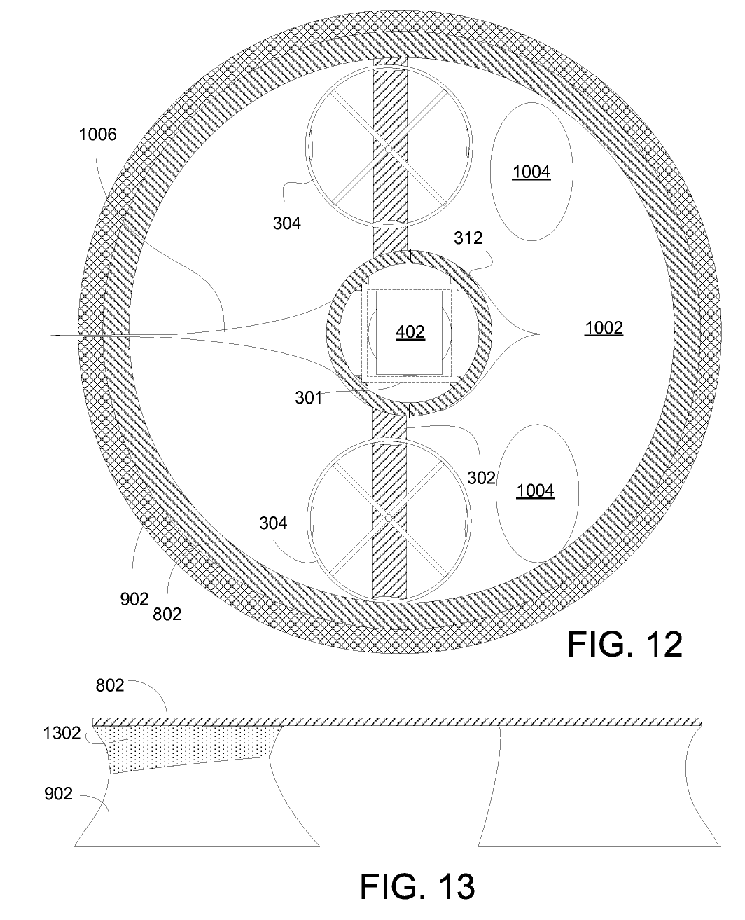

FIG. 12 is a top plan view illustrating an exemplary embodiment of a detail of the hybrid co-generation energy tower 300 of FIG. 2B, according to the present invention. FIG. 12 is a portion of FIG. 10 turned at right angles to align with FIG. 13.

FIG. 13 is a side cross-sectional view illustrating an exemplary embodiment of a detail of the hybrid co-generation energy tower 300 of FIG. 2B, according to the present invention. FIG. 13 shows sloped filler 1302 that functions to direct the rising hot air to the vents 1004.

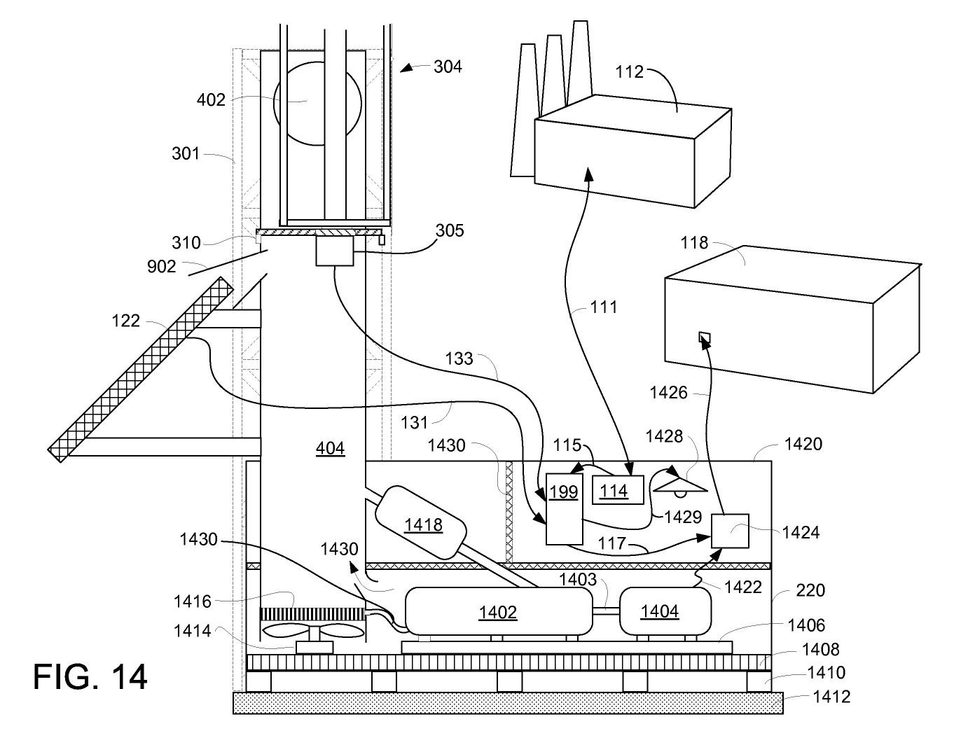

FIG. 14 is a side elevation cutaway view illustrating another exemplary embodiment of a detail of a hybrid co-generation energy tower 1400, according to the present invention. The tower 301, wind turbines 304, solar voltaic array 122, and primary ductwork 404 and 402 is substantially the same as for the embodiment of FIG. 1. The ducting 902 is shown in an alternative form. What is novel are the details of the cogeneration system. The genset housing 220 is elevated above a slab 1412 by feet 1410 and has a grated floor 1408 to allow air flow into the genset housing 220. The generator 1404 is driven through mechanical linkage 1403 by engine 1402, which together form the genset. The genset is mounted on genset carriage 1406 and is elevated above the carriage to enable cooling air flow over the genset. The engine 1402 is cooled using a horizontal radiator, or heat exchanger 1416 over which cooling air is driven by fan 1414. The airflow over the genset is entrained through venturi 1430, recovering about 8% of the waste heat of the engine 1402 and generator 1404. In a particular embodiment, a flapper valve may be provided at venturi 1430 to prevent backflow in unusual weather and/or maintenance conditions. The exhaust from the engine 1402 is expelled through insulated muffler 1418 into ductwork 404, thereby recovering waste heat and kinetic energy from the exhaust. Insulated muffler 1418 shares the upper housing 1420 with electrical equipment (to be discussed below), but is isolated from the electrical equipment by steel bulkhead 1430. Upper housing 1420 is preferably, like the genset housing 220, a forty-foot-long ISO container. The AC output of the generator 1404 is coupled to cogeneration controller 1424 by power conduit 1422.

UPS 199 is housed in the upper housing 1420, and receives DC power from the solar voltaic array 122 through power conduit 131 and from wind turbine generators 305 along power conduit 133. UPS 199 receives AC power through reverse feed switch 114 along power conduit 115. Reverse feed switch 114 receives utility grid power 112 along power lines 111. The remaining connections to reverse feed switch 114 are omitted in this drawing, for simplicity, but are shown in FIG. 1. The DC output of UPS 199 may be used for supplying lamp 1428 (preferably a LED lamp) or other DC-powered device, along DC power conduit 1429. Other external DC loads may be supplied from UPS 199, as previously discussed under FIG. 1. The AC output of UPS 199 is supplied to cogeneration controller 1424. Cogeneration controller 1424 is used to determine how much power is used from the generator 1404 and how much is used from UPS 199. The controller may be preset or may be made adaptive to system variables.

Those of skill in the art, informed by this disclosure, will appreciate the variations of this embodiment that may be made. For example, in an embodiment in which the amount of land is critical, the housings 220 and 1420 may be redesigned to be mounted vertically. Likewise, those wishing to power generator 1402 with hydrogen (or just produce hydrogen) may add an additional housing for the hydrogen generating and handling features described above under FIG. 1. In a particular embodiment, the DC loads supplied from UPS 199 may be independent of facility needs.

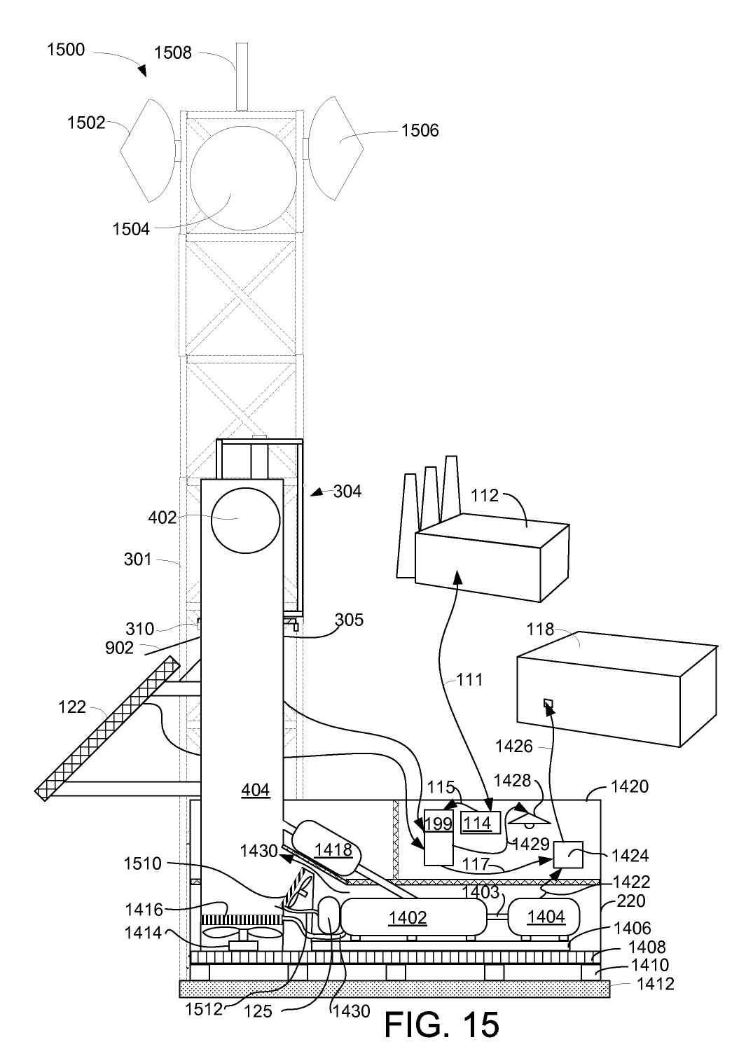

FIG. 15 is a side elevation cutaway view further illustrating the exemplary embodiment 1500 of details of a hybrid co-generation energy tower 1400 of FIG. 14, according to the present invention. The tower 301 used for the renewable energy systems discussed above may also serve other purposes. For example, tower 301 may also be used as a communications tower, supporting various radio frequency antennas 1508 and microwave relay antennas 1502, 1504, and 1506. Other antennas, such as, without limitation, cell phone tower antennas, police band antennas, and fire band antennas, may be employed. In a particular embodiment, the antenna may include a radar antenna, with the entire embodiment configured as a remote radar installation. The possibilities for varied applications are vast, and are not limited to exemplary embodiments described here.

FIG. 15 also includes a CNG 4-stage compressor 125 and a heat exchanger 1510, which diagrammatically represents the intercoolers of the 4-stage compressor 125, while the thermal conduit 1512 diagrammatically represents the coupling of the heat to the heat exchanger 1510. The hydrogen production and handling features of the embodiment of FIG. 1 are included in embodiment 1500, but are not shown. The flow rates between heat exchanger 1416 and 1510 are controlled to prevent either from forcing backflow through the other. A flapper valve at venturi 1430 may be required to prevent backflow of heat exchanger 1510 and 1416 output.

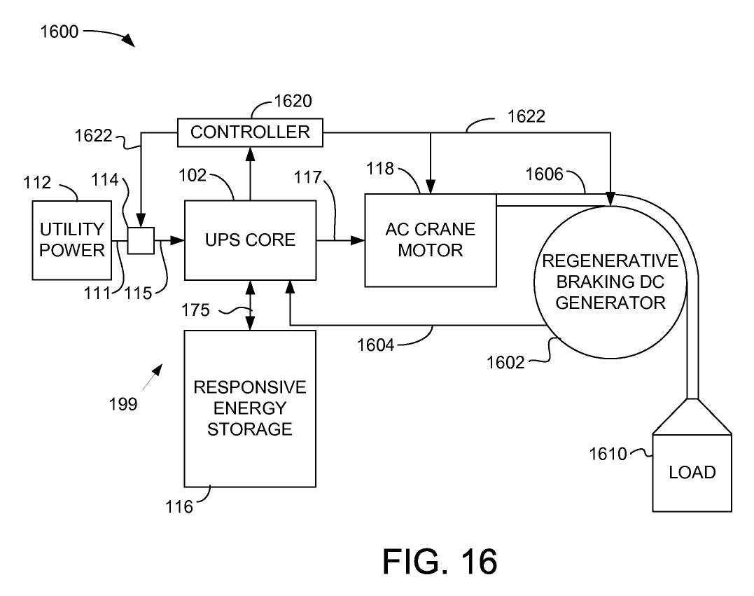

FIG. 16 is a block diagram illustrating a regenerative cargo crane 1600 incorporating UPS 199, including UPS core 102 and responsive energy storage 116 of the renewable energy power systems 100 of FIG. 1, according to the present invention. The regenerative cargo crane 1600 uses AC crane motor 118, which is the primary load 118 coupled to UPS 199 via AC power conduit 117, to lift load 1610 through mechanical linkage 1606, preferably a cable and reel mechanism. AC crane motor 118 is supplied with AC power from the utility AC power 112 via AC power conduit 111, through SES reverse feed switch 114, and through AC power conduit 115. When the load 1610 is mechanically lowered, the AC crane motor 118 is disconnected from the load, as by a clutch (not shown), and the mechanical linkage 1606 drives regenerative braking DC generator 1602 to generate DC power. The cable plays out from the mechanical linkage 1606 to lower the mechanical load 1610. The generated DC power is supplied to UPS core 102 via a DC power conduit 1604 and through a DC source coupling to the multi-port DC bus 108 (FIG. 1) thereof. With no demand to the AC crane motor 118 during DC generation, the utility power 112 is interrupted at switch 114, preferably the SES reverse feed switch 114 configured for this application. During DC generation, the UPS core 102 stores the excess DC energy in responsive energy storage 116 via power conduit 175. Responsive energy storage 116 is preferably a bank of ultra capacitors sized for the amount of DC power generated by lowering a load plus any other loads supported through the UPS core 102.

During the next lifting cycle, the regenerative braking DC generator 1602 is disconnected from the load, as by a clutch (not shown, preferably a magnetic clutch), and the AC crane motor has high demand for power. The DC power from the responsive energy storage 116 flows onto the multi-port DC bus 108 via power conduit 175 to make up the short-fall from the utility power 112, which is coupled through switch 114 during lifting operations. As the AC crane motor 118 demands more power for lifting, the DC power on the multi-port DC bus 108 in UPS core 102 will tend to fall, and the stored DC power in the responsive energy storage 116 will make up the difference, assisting in the lifting of mechanical load 1610.

Controller 1620 is an external DC load supplied with DC power from the UPS 199. Controller 1620 controls the switch 114, the AC crane motor 118 and its magnetic clutch (not shown), and the regenerative braking DC generator 1602 and its magnetic clutch (not shown) through control signals sent over control lines 1622.

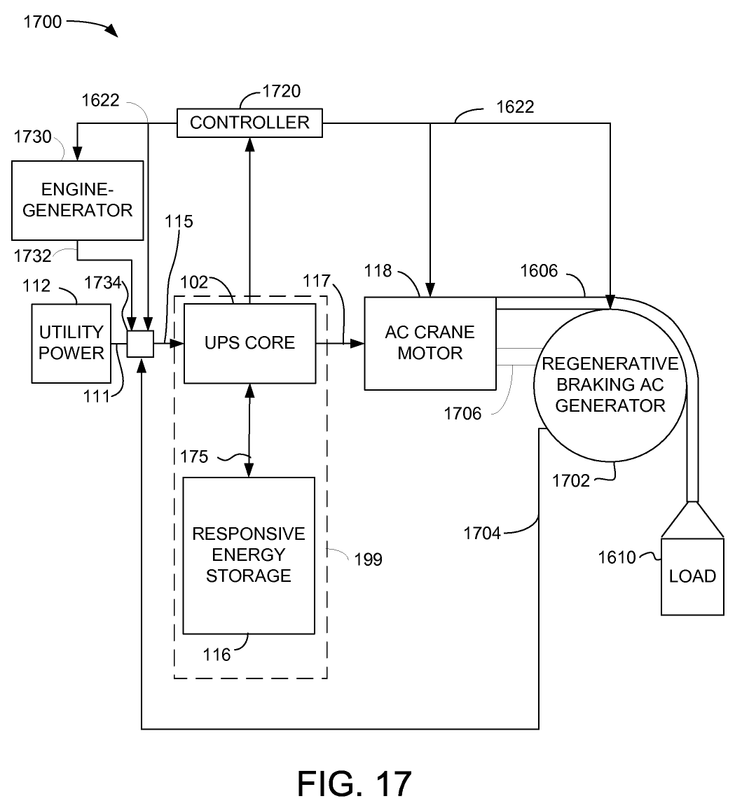

FIG. 17 is a block diagram illustrating a second regenerative cargo crane 1700 incorporating essential features of the renewable energy power systems of FIG. 1, according to the present invention. UPS 199 includes UPS core 102, responsive energy storage unit 116, and conduit 175 between the responsive energy storage unit 116 and the DC bus 108 of the UPS core 102. AC circuit device 1734, which may include SES reverse feed switch 114, receives AC power from the utility grid 112 via power conduit 111, from engine-generator set 1730 via power conduit 1732, and from regenerative braking AC generator 1702 via power conduit 1704. AC circuit device 1734 may provide parallel use of power form all three sources. In an alternate embodiment, AC circuit device 1734 may enable selection of fewer than three power sources 1702, 112, and 1730 to send through AC power conduit 115 to the UPS core 102 of the UPS 199. The AC power output of UPS 199 supplies AC crane motor 118, as the primary load, over power conduit 117. AC crane motor 118 is mechanically coupled to the regenerative braking AC generator 1702 by shaft 1706. In another preferred embodiment, AC crane motor 118, shaft 1706 and regenerative braking AC generator 1702 are a single integral unit. When the load 1610 is raised, AC crane motor 118 draws power from the responsive energy storage unit 116, as well as the utility grid 112, motor-generator 1730. When the load is lowered, the regenerative braking AC generator 1702 supplies power to the UPS 199 through AC circuit device 1734. The excess power supplied by the regenerative braking AC generator 1702 is stored in the responsive energy storage unit 116, to be used during the next lifting cycle. Controller 1720, powered by DC from UPS 199, maintains synchronization of the AC signals, preferably 3-phase, to ensure that the AC sources 112, 1730, 1702 can run in parallel with each other.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. A renewable energy power system comprising:
a) a UPS, wherein said UPS comprises at least one rapidly responsive energy storage means;
b) at least one UPS core in said UPS, said at least one UPS core comprising:
i. at least one multi-port DC bus; and
ii. at least one external DC coupling operable to assist in coupling at least one external DC load to said at least one multi-port DC bus, wherein said at least one DC load is located exterior to said UPS; and
c) wherein said at least one rapidly responsive energy storage means is electrically coupled to said at least one multi-port DC bus.

2. The renewable energy power system of claim 1, further comprising at least one external DC coupling operable to assist in coupling at least one external DC source to said at least one multi-port DC bus, wherein said at least one external DC source is external to said at least one UPS.

3. The renewable energy power system of claim 2, wherein said at least one external DC source comprises one of:
a) at least one wind turbine; and
b) at least one regenerative braking generator.

4. The renewable energy power system of claim 3, wherein said at least one wind turbine comprises:
a) a pair of pole-mountable wind turbines;
b) a pole; and
c) at least one support structure operable to support said pair of pole-mountable wind turbines on said pole.

5. The renewable energy power system of claim 4, wherein said support structure is operable to:
a) move vertically on said pole; and
b) move said pair of pole-mountable wind turbines rotationally about said pole, responsive to changes in wind direction.

6. The renewable energy power system of claim 4, further comprising:
a) at least one solar voltaic array; and
b) ductwork for directing air bearing waste heat from said at least one solar voltaic array, wherein said air bearing said waste heat is ducted to assist in driving said at least one wind turbine.

7. The renewable energy power system of claim 6, wherein said at least one solar voltaic array is operable to be:
a) moved vertically on said pole; and
b) rotated at least partially about said pole.

8. The renewable energy power system of claim 6, further comprising an AC engine-generator, wherein waste engine-generator heat from said engine-generator is exchanged to driven air, said heated driven air then being ducted and vented to assist in driving said at least one wind turbine.

9. The renewable energy power system of claim 2, wherein:
a) said at least one external DC source comprises at least one parking lot solar power system;
b) said at least one external DC load comprises at least one automotive charging station; and
c) said UPS receives AC power from one of a utility grid and a local AC generator.

10. The renewable energy power system of claim 9, wherein said local AC generator is fueled with hydrogen gas produced by an electrolyzer at least partially powered concurrently by:
a) said solar voltaic array;
b) said at least one wind turbine; and
c) AC grid power, all combined though said UPS.

11. The renewable energy power system of claim 9, wherein said at least one parking lot solar power system comprises:
a) a parking lot;
b) a roof for providing shaded parking for at least one vehicle, said roof supported above at least a portion of said parking lot;
c) at least one solar voltaic array mounted on said roof,
d) a housing operable to support and assist in protecting:
i. said UPS core;
ii. a reverse feed switch;
iii. a backup AC generator; and
iv. said at least one rapidly responsive energy storage means;
e) a power conduit from said at least one solar voltaic array to said at least one external DC coupling operable to assist in coupling said at least one DC source; and
f) a power conduit from said at least one external DC coupling, operable to assist in coupling said multi-port DC bus to said at least one automotive charging station.

12. A renewable energy power system comprising:
a) at least one UPS having the combination of:
i. a rectifier, operable to receive AC grid power and to rectify said AC grid power to DC power output;
ii. an inverter, operable to receive DC bus power and to invert said DC bus power to AC line power output;
iii. at least one multi-port DC bus electrically coupling said rectifier to said inverter; and
iv. at least one external DC coupling from said at least multi-port DC bus operable to assist in coupling at least one external DC load to said at least one multi-port DC bus, wherein said at least one external DC load is external to said UPS; and
b) at least one responsive energy storage means electrically coupled to said at least one multi-port DC bus.

13. The renewable energy power system of claim 12, further comprising at least one external DC coupling to said at least multi-port DC bus operable to assist in coupling at least one external DC source, wherein said at least one external DC source is external to said at least one UPS.

14. The renewable energy power system of claim 13, wherein said at least one DC source comprises at least one pole-mountable wind turbine.

15. The renewable energy power system of claim 14, wherein said at least one DC source further comprises at least one solar voltaic array, said at least one solar array comprising ductwork for air bearing waste heat from said at least one solar voltaic array, wherein said air bearing said waste heat is ducted to assist in driving said at least one wind turbine.

16. The renewable energy power system of claim 13, wherein said at least one DC source comprises at least one parking lot solar power system.

17. The renewable energy power system of claim 16, wherein said at least one DC load external to said at least one UPS comprises at least one vehicle charging station.

18. The renewable energy power system of claim 17, wherein said at least one vehicle charging station comprises an AC outlet and a plurality of DC outlets, wherein each DC outlet of said plurality of DC outlets is operable to supply a unique DC voltage.

19. The renewable energy power system of claim 12, wherein said rectifier is further operable to receive at least one of:
a) an AC output of an AC regenerative braking generator; and
b) an AC output of an engine-generator set.

20. A renewable energy power system comprising:
a) at least one UPS having the combination of:
i. a rectifier, operable to receive AC grid power and to rectify said AC grid power to DC power output;
ii. an inverter, operable to receive DC bus power and to invert said DC bus power to AC line power output;
iii. at least one multi-port DC bus electrically coupling said rectifier to said inverter; and
iv. at least one external DC coupling from said at least multi-port DC bus operable to assist in coupling at least one external DC load to said at least one multi-port DC bus, wherein said at least one DC load is external to said UPS; and
v. at least one external DC coupling to said at least multi-port DC bus operable to assist in coupling at least one external DC source to said at least one multi-port DC bus, wherein said at least one DC source is external to said UPS; and
b) at least one responsive energy storage unit electrically coupled to said at least one multi-port DC bus.

21. The renewable energy power system of claim 20, wherein:
a) said at least one DC source comprises at least one wind turbine generator; and
b) said at least one DC load comprises at least one of a lamp, an automobile-charging station, an electrolyzer, and a DC-powered device.

22. The renewable energy power system of claim 20, wherein said at least one DC source comprises a solar voltaic array.

23. The renewable energy power system of claim 22, wherein said at least one wind turbine generator is driven by a wind turbine, said at least one wind turbine assisted in its rotation by a flow of waste-heated air.

24. The renewable energy power system of claim 23, wherein said waste-heated air comprises at least one of:
a) exhaust from an engine of an engine-generator set;
b) cooling air heated by a heat exchanger of said engine-generator set;
c) air heated by convection over the surfaces of said engine-generator set;
d) air bearing waste heat from said solar voltaic array.

25. The renewable energy power system of claim 20, further comprising an engine-generator set that is one of:
a) part of a cogeneration system that cogenerates:
i. said AC line power output from said at least one UPS; and
ii. AC power output from said engine-generator set; and
b) part of a parallel AC power supply to said rectifier, said parallel AC power supply further comprising AC power from an AC regenerative braking generator.

26. The renewable energy power system of claim 25, wherein:
a) said engine of said engine-generator set drives a compressor having intercoolers;
b) heat from said intercoolers of said compressor is exchanged to air to produce heated air; and
c) said heated air is used to assist the rotation of said at least one wind turbine.

27. The renewable energy power system of claim 26, further comprising:
a) at least one hydrogen producer powered as an external DC load of said UPS;
b) a conduit for compressed natural gas from said compressor; and
c) at least one hythane mixing facility coupled to said at least one hydrogen producer and said conduit for compressed natural gas and operable to mix said hydrogen and said compressed natural gas.

28. A method of operating a renewable energy power system comprising the steps of:
a) providing a UPS with a multi-port DC bus between an AC/DC rectifier and a DC/AC inverter; and
b) supplying DC power from said multi-port DC bus to at least one DC load external to said UPS via a DC power coupling to said multi-port DC bus.

29. A method of operating a renewable energy power system comprising the steps of:
a) providing a source of air bearing waste heat from at least one of a renewable energy production source and an engine fueled with renewable energy; and
b) controlling the flow of said heated air to assist in driving a wind turbine.
